(19) United States
(12) Patent Application Publication
(10) Pub. No.: US 2006/0103580 A1
(43) Pub. Date: May 18, 2006

(54) Integrated antenna structures, integrated electronic component structures and method for the production thereof

(75) Inventors: Walter Aichholzer, Hemmingen (DE); Gunter Reichart, Affalterbach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG

(21) Appl. No.: 10/527,465

(22) PCT Filed: Aug. 22, 2003
(86) PCT No.: PCT/EP03/09331

§ 371 Date: Sep. 20, 2005

(30) Foreign Application Priority Data
Sep. 12, 2002 (DE) 102 42 522.1

(51) Int. Cl. H01Q 1/32

(52) U.S. Cl. 343/713; 343/873

(57) ABSTRACT

Integrated antenna structures, integrated electronic component structures and a method for the production thereof are provided. The basic concept consists of plastic components (1, 2), for example of a motor vehicle, have coating films (3, 3a*, 3b, 3c) as a surface finish and which are furnished with electronic components, in particular planar antenna architectures or structures (4), integrated in films.

This application claims priority to International Patent Application No. PCT/EP03/09331, filed Aug. 22, 2003, designating the United States of America, and German Application DE 102 42 522.1 filed on Sept. 12, 2002, the entire disclosure of which is incorporated herein by reference.

### BACKGROUND AND SUMMARY OF THE INVENTION

The invention relates to integrated antenna structures and to a method for the production thereof.

German reference DE 42 15 659 A1 discloses an antenna arrangement having at least two antenna components integrated in a motor vehicle part composed of electrically nonconductive material. In this case, a plurality of individual components of the antenna are formed integrally from an electrically conductive structure, preferably as an antenna film. The antenna film can then be integrated, i.e., mounted, in a simple manner into the motor vehicle part, for example, a plastic fender.

German reference DE 196 36 584 C1 discloses a fender for receiving a vehicle antenna. In this case, various antenna receiving locations, for example in the form of ribs, channels and mounts, for receiving an antenna arrangement are provided on a fender.

German reference DE 100 60 603 A1 discloses a bodywork part with integrated antenna. In this case, a bodywork part contains an integrated antenna arrangement and with a carrier unit, on which the antenna arrangement is arranged in a releasable manner.

German reference DE 100 25 130 A1 discloses an antenna integrated into bodywork components of a vehicle. The antenna is at least partly accommodated in a bodywork component produced with a plastic superstructure and a stiffening metal substructure. The metal substructure forms a part of the antenna in this case.

Furthermore, the formation of a spiral antenna above a cylindrical cavity integrated in the lid of the trunk is disclosed in “Frequenzunabhängiges Antennenkonzept für mobile Kommunikation und Navigation” [Frequency-independent antenna concept for mobile communication and navigation] by E. Geschwendtner, W. Wiesbeck, published by the “antennas” committee of experts in the ITG im VDE, Starnberg, Oct. 12/13, 2000.

“Multifunction Conformal Antennas for Automotive Application” by Christian Renard, Bernard Perpere, in Ingénieurs de l'Automobile, May 2000, pages 68 to 70, discloses fitting a spiral, printed antenna in the center of a metal roof. A cylindrical metallic cavity is arranged on the underside of the spiral. The antenna is covered externally by a protective layer and a nonmetallic paint.

Finally, “Breitbandige Multifunktionsantennen für konformen Einbau in Kraftfahrzeugen” [Broadband multifunction antennas for conformal incorporation in motor vehicles], dissertation by Dr.-Ing. E. Geschwendtner, University of Karlsruhe, 2001, pages 130 to 142, discloses accommodating an antenna with a metallic cavity, on which a spiral antenna is situated, in a metallic lid of a trunk, the top side of the antenna conforming with the surface of the lid of the trunk and the spiral being visible when viewed from above. As an alternative, it is proposed to fit an antenna spiral under a plastic tailgate and shield it with a large-area metallic reflector below the spiral.

German reference DE 41 21 333 C2 shows a film antenna which is provided with an electrically nonconductive carrier material and radiating elements formed as electrically conductive coatings of the carrier material. The carrier material is coated exclusively on one side, the conductive coating comprising copper and the carrier material including polyimide or epoxy glass fiber film.

However, integrated antennas of this type are complicated and cost-intensive to produce since they require special configurations, for example of the tailgate (metallic cavity under the antenna; plastic tailgate with antenna film applied on the inside and additional reflector etc.). Furthermore, they impair the design if they are visible externally. No solutions are currently known for integrating other electronic components for example in surfaces of motor vehicle paneling parts.

Therefore, it is an object of the present invention to form integrated antenna structures and also a method for the production thereof which do not impair the design and which are simple and cost-effective to produce.

As a result of the present invention, it is possible to obtain simple and cost-effective integrated antenna structures or integrated electronic component structures which do not impair the design since they are not visible on the surface of the bodywork part.

These and further objects, features and advantages of the present invention will become apparent from the description below of preferred exemplary embodiments of the invention in conjunction with the drawing.

### BRIEF DESCRIPTION OF THE DRAWINGS

FIG. 1 shows the construction of an integrated antenna structure in accordance with a first exemplary embodiment,

FIG. 2 shows the construction of an integrated antenna structure in accordance with a second exemplary embodiment,

FIG. 3 shows the construction of an integrated antenna structure in accordance with a third exemplary embodiment, and

FIG. 4 shows the construction of an integrated antenna structure in accordance with a fourth exemplary embodiment.

### DETAILED DESCRIPTION OF THE DRAWINGS

Four different exemplary embodiments of the construction of an integrated antenna structure according to the invention and of the method for the production thereof are specified by way of example below. The integrated antenna structure is used as an example in this case. Instead of the integrated antenna structure, it is likewise possible to use an integrated electronic component structure as long as the electronic component is planar and integrable in a film.

The basic concept of the present invention consists of plastic components, for example of a motor vehicle, which are furnished with coating films as a surface finish and which include electronic components, in particular planar antenna architectures or structures, which are integrated in films.

In this way, the production costs can be reduced, design freedom increases, and valuable structural space is saved while promoting a modular design.

For this purpose, a process-integrated application of an antenna film to a plastic component is effected during the primary shaping operation.

In a first exemplary embodiment of the invention, the integrated antenna structure used is constructed according to the invention shown in FIG. 1.

The layer sequence according to the invention is as follows from the interior outward substrate layer 2 is applied to a lining layer 1. A coating film 3 is formed on said substrate layer 2 on the opposite side to the lining layer 1. The coating film 3 includes a coating-film carrier layer 3a*, a coating-film color layer 3b and a coating-film clearcoat layer 3c that are formed one on top of the other. The antennas 4, forming the integrated antenna structure, are integrated into the coating-film carrier layer 3a*. For the purpose of making contact with said antennas 4, a contact-making layer 5 is formed between the coating-film carrier layer 3a* and the substrate layer 2.

The method for the production of an integrated antenna structure according to the invention in accordance with the first exemplary embodiment will now be discussed in greater detail below.

A first step provides a continuous, deformable coating-film carrier layer 3a*, which simultaneously represents an antenna film, on a surface by means of coating, cladding or metallizing with an antenna architecture with antennas 4 and a contact-making layer 5 for making contact with said antennas 4 (step S1). A coating-film color layer 3b and a coating-film clearcoat layer 3c are then applied layer by layer on the opposite surface of the coating-film carrier layer 3a* by means of coating-technological production (step S2). These layers may also be applied prior to the production of the antenna architecture, i.e. step S2 may be performed before step S1 without any problems. This concludes the production of the coating film 3 comprising the coating-film carrier layer 3a*, the coating-film color layer 3b and the coating-film clearcoat layer 3c. The final processing steps include thermoforming of the coating film 3 containing antennas 4 (step S3), component primary shaping (step S4) and curing of the coating-film clearcoat layer 3c, for example by means of UV light (step S5).

The second exemplary embodiment of the invention represents an alternative embodiment of the construction of an integrated antenna structure and also the production method thereof.

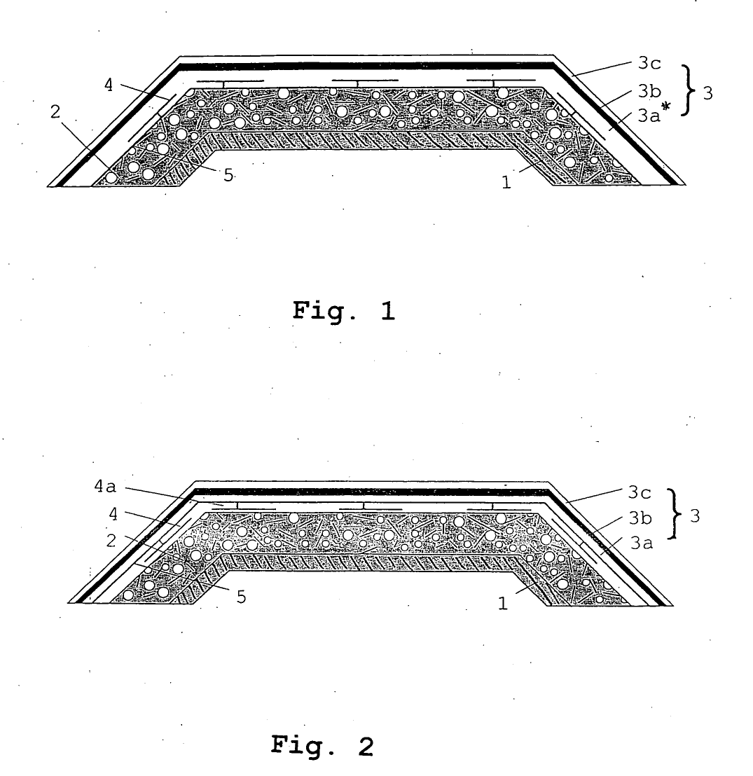

The layer sequence according to the invention from the interior outward is shown in FIG. 2. A substrate layer 2 is applied on a lining layer 1. A deformable antenna film 4a, into which interconnected antennas 4 are integrated, is formed on the substrate layer 2 on the opposite side to the lining layer 1. For contact-making purposes, a metallic coating or contact-making layer 5 is formed for the purpose of connecting the individual antennas 4 on the surface of the antenna film 4a. A coating film 3 is, in turn, formed on the contact-making layer 5a. The coating film has, in succession from the interior outward, a coating-film carrier layer 3a, a coating-film color layer 3b and a coating-film clearcoat layer 3c.

The method for the production of an integrated antenna structure in accordance with the second exemplary embodiment is described below:

In the second exemplary embodiment, a first step S1 involves producing a separate, continuous, deformable antenna film 4a with antennas 4 and a contact-making layer 5 by coating, cladding or metallizing a film layer. In a further step S2, which may be performed at the same time as or in time-staggered fashion with respect to the first step S1, i.e. before or after the first step S1, a coating film 3 is produced by coating technology. For this purpose, a coating-film carrier layer 3a is coated with a coating-film color layer 3b and a coating-film clearcoat layer 3c. Afterward, the antenna film 4a is laminated onto the coating film 3 in a third step (S3). This film composite including antenna film 4 and coating film 3 is then jointly thermoformed in the fourth step S4. The concluding fifth and sixth steps S5 and S6 then effect component deformation and curing of the coating-film clearcoat layer 3c, for example by means of UV light.

A further variant of the antenna structure according to the invention and also a method for the production thereof will now be described.

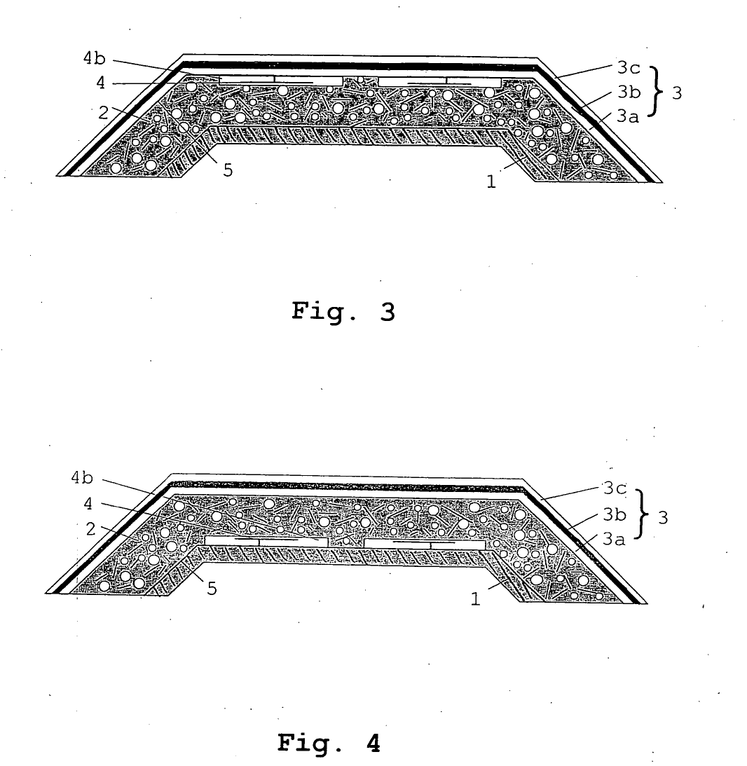

The integrated antenna structure in accordance with a third exemplary embodiment as shown in FIG. 3 includes a lining 1, a substrate 2, which is applied on the latter and into which a non-deformable antenna film 4b is embedded in selected regions. A coating film 3 having a coating-film carrier layer 3a, a coating-film color layer 3b and a coating-film clearcoat layer 3c, in this order, is formed on the substrate 2 or in regions in which the antenna film 4b is embedded.

The method for the production of this antenna structure in accordance with the third exemplary embodiment includes the following steps. In a first step S1 a coating film 3 is produced by coating technology by coating a coating-film carrier layer 3a with a coating-film color layer 3b and a coating-film clearcoat layer 3c. Afterward, the coating film 3 thus produced is thermoformed in a step S2. A third step S3 then involves producing a separate, non-deformable antenna film 4b and also a contact-making layer 5 for making contact with the antennas 4, which are integrated in the antenna film, by coating, cladding or metallizing a film layer. As an alternative, step S3 may also be carried out before step S1. In the fourth step S4, a non-deformable antenna film 4b is laminated onto the already deformed coating film 3. Finally, a component primary shaping and a (UV) curing of the coating-film clearcoat layer 3c are then effected in steps S5 and S6.

In the fourth exemplary embodiment of the invention, the construction of the antenna structure, in particular the layer sequence is as follows and as shown in FIG. 4.

The antenna structure in accordance with a fourth exemplary embodiment comprises a lining 1, a contact-making layer 5—applied to the lining 1—for an antenna film 4b with antennas 4 and, above the latter, a substrate 2, into which an antenna film 4b is embedded in selected regions toward the contact-making layer 5. A coating film 3 including a coating-film carrier layer 3a, a coating-film color layer 3b and a coating-film clearcoat layer 3c in this order are formed on the substrate 2.

The production method for the integrated antenna structure in accordance with the fourth exemplary embodiment has the following steps. Firstly, in a step S1, a coating film 3 is produced by coating technology by coating a coating-film carrier layer 3a with a coating-film color layer 3b and a coating-film clearcoat layer 3c. The coating film 3 is subsequently thermoformed in step S2. Finally, a third step S3 involves producing a separate, non-deformable antenna film 4b with a contact-making layer 5 on one of its surfaces by coating, cladding or metallizing a film layer. The subsequent step S4 effects component primary shaping including double film application by mold-side introduction of the coating film 3 and gate-side introduction of the non-deformable antenna film 4b. Finally, the coating-film clearcoat layer 3c is cured by means of UV light, for example, in step S5.

By means of the integrated antenna structures in accordance with the first to fourth exemplary embodiments which are constructed and produced in the manner described above, an antenna structure can thus be integrated into plastic components in a simple manner cost-effectively and without influencing the design and with a saving of structural space.

It is likewise possible, instead of an antenna structure, also to integrate arbitrary electronic components into a paneling part, for example, as long as they are planar and integrable in films.

1.-4. (canceled)

5. An integrated antenna structure for integration into plastic paneling parts furnished with coating films as a surface finish and having an antenna structure element integrated into an antenna film wherein
the coating films include a coating-film carrier layer, a coating-film color layer and a coating-film clearcoat layer, wherein
the antenna film is formed by the coating-film carrier layer, into which a plurality of antennas are integrated, said antenna structure further including,
a substrate layer arranged on a surface of the antenna structure element integrated into the coating-film carrier layer, a lining layer being arranged on said substrate layer, and
a contact-making layer making contact with the plurality of antennas integrated into the coating-film carrier layer,
said contact-making layer being formed between the coating-film carrier layer and the substrate layer.

6. A method for the production of an integrated antenna structure for paneling parts furnished with coating films as a surface finish and being provided with an antenna structure element integrated into an antenna film, comprising the steps:
providing a continuous, deformable coating-film carrier layer, which forms an antenna film on a surface by one of coating, cladding and metallizing with an antenna architecture having a plurality of antennas and providing a contact-making layer for making contact with said plurality of antennas;
(S2) layer-by-layer application of a coating-film color layer and a coating-film clearcoat layer on a surface of the coating-film carrier layer which is opposite to the surface provided with the antenna architecture;
(S3) thermoforming of the coating film which is provided with the antenna architecture and is formed by the coating-film carrier layer, the coating-film color layer and the coating-film clearcoat layer;
(S4) performing a component primary shaping; and
(S5) curing of the coating-film clearcoat layer.

7. The method for the production of an integrated antenna structure as claimed in claim 6, wherein step S2 is executed prior to step S1.

8. The method for the production of an integrated antenna structure as claimed in claim 6, wherein
the coating-film clearcoat layer is cured by irradiation with UV light.

9. The method for the production of an integrated antenna structure as claimed in claim 7, wherein
the coating-film clearcoat layer is cured by irradiation with UV light.

10. An integrated antenna structure for paneling parts, comprising:
an antenna structure element integrated into an antenna film,
a coating film having a coating film carrier layer;
a coating film color layer and a coating film clearcoat layer wherein said antenna film is formed by the coating film carrier layer and includes a plurality of integrated antennas;
a substrate layer arranged on a surface of the antenna structure element integrated into the coating film carrier layer;
a lining layer arranged on said substrate layer;
a contact layer making contact with the plurality of antennas wherein said contact making layer is positioned between the coating-film carrier layer and the substrate layer.

11. A method for production of an integrated antenna structure, comprising the steps:
(a) providing a first surface with a continuous deformable coating film carrier layer to form an antenna film on said first surface by one of coating, cladding and metallizing with an antenna architecture having a plurality of antennas;
(b) providing a contact-making layer for contacting said plurality of antennas;
(c) applying a coating film color layer and a coating film clearcoat layer on a second surface of the coating film carrier layer which is opposite said first surface;
(d) thermoforming the product of steps (a), (b) and (c);
(e) performing a component primary shaping of said product; and
(f) curing the coating film clearcoat layer.

13. The method of claim 12, wherein step (b) is executed prior to step (a).

14. The method for the production of an integrated antenna structure as claimed in claim 12, wherein
the coating-film clearcoat layer is cured by irradiation with UV light.

15. The method for the production of an integrated antenna structure as claimed in claim 13, wherein
the coating-film clearcoat layer is cured by irradiation with UV light.
